(19) United States
(12) Patent Application Publication
(10) Pub. No.: US 2006/0081176 A1
(43) Pub. Date: Apr. 20, 2006

(54) Surfactant applicator for solution casting system and method of use to produce a film

(76) Inventors: Timothy J. Boyle, Gary, IN (US); Erik Peterson, Hobart, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/241,392

(22) Filed: Sep. 30, 2005

Related U.S. Application Data
(63) Continuation-in-part of application No. PCT/US04/10335, filed on Apr. 2, 2004.
(60) Provisional application No. 60/459,686, filed on Apr. 2, 2003.

(51) Int. Cl. B05C 1/00; B05C 1/08; B05C 1/06

(52) U.S. Cl. 118/258; 118/200; 118/203

(57) ABSTRACT

A solvent band casting system, roll coating apparatus, and method of using the same are disclosed. The system includes a tank for mixing and/or storing a polymer solution for a band casting machine having at least a first and a second rotating drums about which a continuous metal band is tensioned to travel with the rotation of the drums. A sheeting die applies the polymer solution from the tank to the metal band where a drying chamber, enclosing a least a portion of the metal band downline of the sheeting die, is used to remove solvent from the polymer solution as it travels in a thin sheet on the metal band. A roll coater surfactant applicator in communication with a supply of surfactant and a portion of the band transfers fluid surfactant to the casting surface. In addition, the use of a surfactant to substantially reduce or eliminate bubbles in the polymer film product is disclosed, as well as the mechanisms by which the surfactant is believed to facilitate bubble reduction. Finally, a system controller can be connected to monitor and/or control at least one component of the system.

### CROSS REFERENCE TO RELATED APPLICATIONS

This is a continuation-in-part of application PCT/US04/10335, filed Apr. 2, 2005, which claims the benefit under 35 U.S.C. §119(e) of U.S. Provisional Patent Application Ser. No. 60/459,686 filed Apr. 2, 2003.

### BACKGROUND

1. Technical Field

The disclosure relates generally to a solution casting system. Particularly, the invention relates to roll coating system for a solution casting system and the use of a surfactant in a band casting system to produce a substantially bubble-free, thin, water-soluble film. As to the water soluble film, the use of the surfactant has one or more functions such as improving the quality of the film product by reducing or eliminating the occurrence of bubbles.

2. Brief Description of Related Technology

Though the general technology for producing plastic materials has been used for decades, solvent-film casting is attracting increasing interest. One of the reasons is that specific requirements in the fields of water-soluble packaging and other related applications can only be met by this technology.

The development of a continuous process to manufacture thin plastic films was closely linked to the emerging photographic industry starting from the end of the 19^{th} Century. In those times, no other technology was available for industrial film forming, and polymer science was also still in its infancy. Two different technologies were soon developed: (1) casting on wheels or large drums; and, (2) casting onto endless flexible metal belts. Surprisingly, both are still in use today, together with a third technology, casting onto moving plastic films. However, since the development of extrusion technologies for the production of thermoplastic polymer films, the importance of solvent casting methods has declined. Today, solvent casting is a specific manufacturing method which is used for niche markets and films with specific and high quality requirements.

Typical solvent casting systems utilize an organic solvent such as acetone, aniline, dimethyl sulfoxide (DMSO), benzene, dimethyl formamide (DMF), methyl ethyl ketone (MEK), ethyl acetate, ethylene dichloride, toluene, tetrahydrofuran, and the like. Such solvents usually necessitate a complex solvent vapor recovery and rehabilitation system. Further, human and environmental exposure to these solvents is most undesirable, and they may present various other safety concerns, such as explosion hazards.

The system described herein can overcome these disadvantages by utilizing water as the solvent. No recovery and rehabilitation system is necessary, and environmental and human exposure is a not an issue.

There are many other processes for the formation of films, including calendering, extrusion, plastisol cast systems, and organosol cast systems. Extrusion and calendering are processes which melt the polymer and shape the plastic prior to freezing. Plastisol and organosol casting processes involve the melting of the polymer in a plasticizer matrix, after which the solvent action of the plasticizer forms a film.

### SUMMARY

One aspect of the disclosure is the use of a surfactant applied to the casting surface of a solvent casting system, such as a band casting system. In various embodiments, one or more surfactants can be used for one or more purposes, including to reduce and/or eliminates bubbles in the film product and to facilitate removal of a subsequently-cast polymer film from the casting surface after production.

Another aspect of the disclosure is a roll coater apparatus for applying a surfactant to a casting surface in a solvent casting system, such as a band casting system. For example, the apparatus can include a trough including an overflow drain, a feed conduit having a first end disposed to feed fluid to the interior of the trough, a pump in fluid communication with the feed conduit, a cylindrical roller disposed at least partially inside the trough, and optionally a surfactant remover for removing excess surfactant, for example a felt pad.

Another aspect of the disclosure is a continuous solution casting system, including a rotating casting surface, a polymer solution applicator disposed in proximity to the casting surface, and a roll coating apparatus as described herein disposed beneath the rotating casting surface.

Another aspect of the disclosure is a method of producing solution-cast polymer film, including the steps of continuously feeding surfactant solution to a trough and continuously draining surfactant solution from the trough, transferring surfactant fluid from the trough to a rotating continuous casting surface, then continuously depositing a polymer solution onto the casting surface, then continuously removing solvent from the polymer solution to form a polymer film, and then continuously removing the polymer film from the casting surface.

Further aspects and advantages may become apparent to those skilled in the art from a review of the following detailed description. While the methods and apparatus are susceptible of embodiments in various forms, the description hereafter includes specific embodiments with the understanding that the disclosure is illustrative, and is not intended to limit the invention to the specific embodiments described herein.

### BRIEF DESCRIPTION OF THE DRAWINGS

For further facilitating the understanding of the disclosure, six drawing figures are appended hereto, wherein:

FIG. 1 is a schematic showing one possible embodiment of a band casting system including a roll coater surfactant applicator according to the disclosure;

FIG. 2 is a perspective view illustrating one embodiment of an endless flexible belt of a band casting system according to the disclosure;

FIG. 3 is a front view of one embodiment of a sheeting die of a band casting system according to the disclosure;

FIG. 4 is a perspective view of a roll coater used as a surfactant applicator according to the disclosure;

FIG. 5 is a is a perspective drawing illustrating embodiments of a take-up winder, camera, and scanner according to the disclosure;

FIG. 6 is a side view drawing illustrating embodiments of a vacuum box and blower with a die coater and band according to the disclosure; and

FIG. 7 is a cross-sectional view of another embodiment of a roll coater according to the disclosure, which includes an overflow weir creating primary and secondary chambers in the trough.

### DETAILED DESCRIPTION

The solution cast process offers several unique features which conventional fusion processes lack. In solvent casting, film formation depends upon solubility, not melting. Thus, a wide range of polymeric alloys can be produced by solvent casting. Because the flowability to form a film is provided by the solvent, a pure resin film can be manufactured without adulteration by heat, stabilizers, plasticizers or lubricants. Only additives which are beneficial to the finished product need to be incorporated with the polymer.

Solvent casting can provide a film which has excellent dimensional stability as well as reduction in or freedom from pinholes, gels and other imperfections. Due to the very low heat history which is inherent in a film produced by solvent casting processing, the process can also provide an extended service life to the film.

Additional advantages of the present method, apparatus and system relate to film quality. Film bubbles and pinholes can be detrimental to many film uses. Various aspects of the methods and apparatus disclosed herein allow for the reduction in the frequency and dimensions of such blemishes.

Solution casting may be done effectively through the use of a band casting system, such as that described below. Bubbles and pinholes in a polymer film can be detrimental to many film uses. In producing polymer film, it is desirable to minimize the frequency and dimensions of such blemishes. The method and apparatus described provide a simple, yet effective means of reducing or eliminating bubbles in a polymer film produced using a solution casting system. This improvement in quality is achieved through the application of a surfactant coating to a casting surface before a polymer solution is applied to the surface for casting the film. Preferably, the surfactant is applied continuously, evenly, and reliably.

Without intending to be limited to any particular theory, it is believed that the use of a surfactant to displace air adsorbed at the surface of the casting surface can result in reduction of blemishes in the resulting film. Accordingly, one surfactant for use in the method and apparatus is a surfactant which displaces air from the surface of the particular casting surface used. A suitable surfactant may depend on the material of construction of the casting surface, and can be readily determined by a person of ordinary skill in the art.

Without intending to be limited to any particular theory, it is believed that the use of a surfactant to improve the wetting properties of the polymer solution to be applied can result in reduction of blemishes in the resulting film. Accordingly, one surfactant for use in the method and apparatus is a surfactant which improves the wetting properties of the particular polymer solution to be applied to the particular casting surface. A suitable surfactant may depend on the particular polymer solution to be applied and to the material of construction of the casting surface, and can be readily determined by a person of ordinary skill in the art.

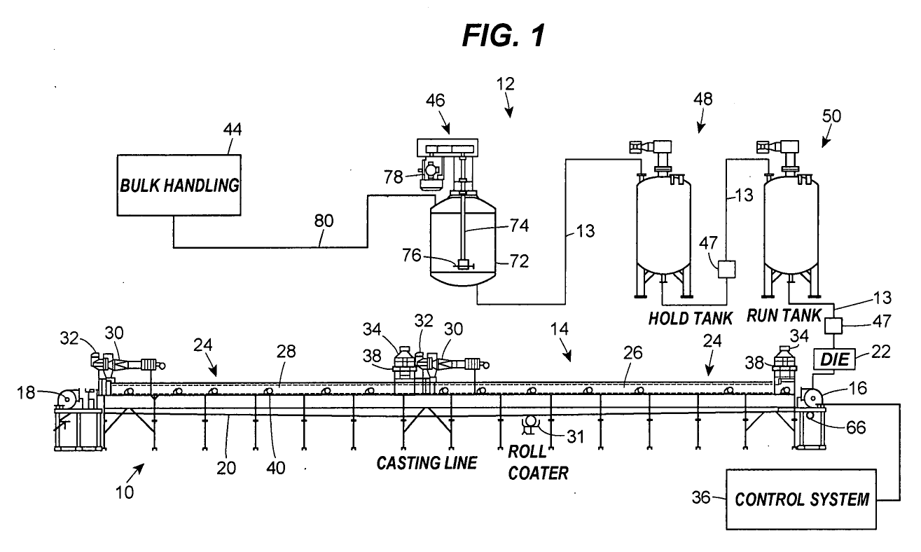

Referring generally to the appended FIGS. 1-7, the method and apparatus can be more readily understood. The disclosed solvent casting system is generally referenced by element number 10 and a surfactant applicator is generally referenced by element number 31 in the following disclosure and drawing FIGS. 1-4. Other components are similarly and consistently numbered throughout the specification and drawings.

“Bubble-free” is a term applied to a film product having a bubble count less than a given threshold based on a full-width optical (e.g., visual) inspection of film sample measuring approximately 4 inches by 55 inches. For the present invention, to qualify as “bubble-free” the number of bubbles of less than 25 microns in diameter should not exceed 50 in the sample film. Optionally, but preferably, the number of bubbles within the range of 25 to 40 microns should not exceed 10. Further optionally, there will be no bubbles of greater than 40 microns in the sample film. When a manual inspection method is used to determine when a film is bubble-free (e.g., inspection of sub-samples under magnification), then a method employing statistical sampling can be used to approximate the total number of bubbles in the full sample. In a preferred embodiment, 14 different locations within the film sample, each measuring approximately 4″×0.25″, will be inspected to determine if the “bubble-free” threshold has been met.

“Upline” refers to the chronological operating position of a component on the film production line which is prior to a reference point.

“Downline” refers to the chronological operating position of a component on the film production line which is after a reference point.

“Line” is the collective sequence of production components utilized by an embodiment of the present invention.

“On-line” is an operating condition of the casting system where film, though not necessarily a marketable product, is being produced.

“Polymer solution” refers to any homogeneous mixture of a polymer dissolved in a suitable solvent. The method and apparatus are particularly suited for a polyvinyl alcohol (PVOH) dissolved in water. The water content of the PVOH solution is preferably within the range of from about 60% by weight to about 85% by weight. While other polymer solutions may be suitable for use with the present invention, the description of the embodiments herein is made with specific reference to the manufacture of PVOH film for packaging.

Because there are so many chemically different types of products to be packaged, packaging films are formulated in different ways. That is, the PVOH resin, plasticizer system and other ingredients vary and provide a range of films with different product compatibility characteristics. One or more different films may be suited to a particular application, with a suitable film grade easily predictable based upon compatibility testing.

“Water soluble” refers to a film which, when exposed to water, begins to dissolve or disintegrate to its smallest components. Polyvinyl alcohol (PVOH) is a hydrophilic polymer and the plasticizers typically used in its manufacture also have an affinity for water. PVOH will absorb moisture from a wet atmosphere and give up moisture to a dry atmosphere. As moisture content increases (even with humidity), a PVOH film will tend to quickly become softer and more elastic, losing tensile properties and increasing in ultimate elongation. Also, the coefficient of friction of a PVOH film will increase with increasing moisture content.

With reference to FIG. 1, the general components of a band casting system can be described. The present embodiment of the solvent band casting system 10 begins with a mixing system 12 for mixing and storing a polymer solution. The mixing system 12 can be a single tank, or, in a preferred embodiment, may comprise a plurality of tanks and attendant piping, pumps and valves to control the flow of the polymer solution among the tanks. In the embodiment shown, the mixing system 12 comprises a bulk handling station 44, a mixer 46 having a mix tank 72, a hold tank 48, and a run tank 50. Each of the tanks or vessels is in flow communication with the mixer 46. A feed line 13 runs from the hold tank 48 to the run tank 50, from where it is pumped to the extrusion die 22 for casting onto the band 20. A filter 47 may be placed between the hold tank 48 and the run tank 50, or between the run tank 50 and the die 22, or both places.

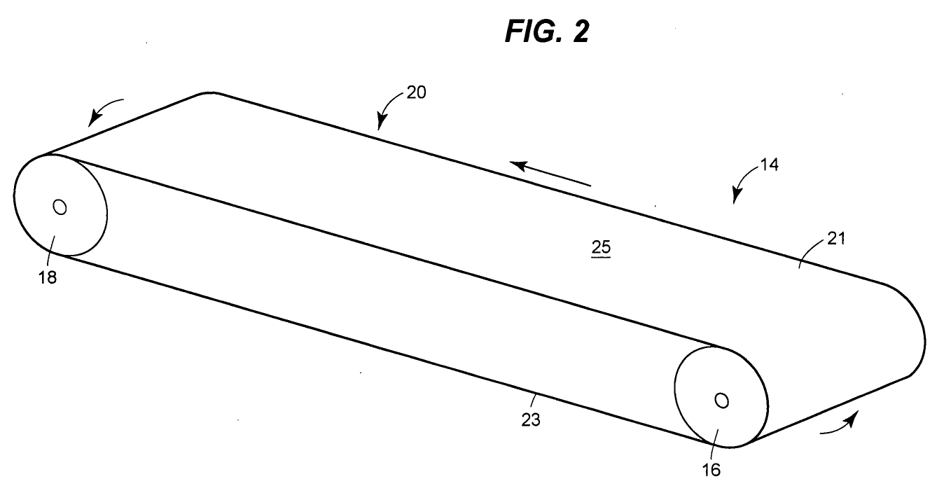

Proximate the mixing system 12, a band casting machine 14 is shown. The band casting machine may be seen in greater detail in FIG. 2. The casting machine 14 is comprised of a first or lead drum 16 and a second or end drum 18 around both of which is wrapped a continuous metal band 20 having a continuous casting surface 25. The drums 16 and 18 travel in the direction indicated by the arrows, imposing a similar revolution of the band 20. In a preferred embodiment, the drums are approximately 65 inches wide and 48 inches in diameter, and the band 20 is approximately 61 inches wide with a circumference of approximately 325 feet. A suitable band casting machine is available from Berndorf Belt Systems, Inc. of Carpentersville, Ill. At any given position, the band has a production or upper portion 21 and a return or under portion 23. The upper portion 21 of the band is used to support the applied polymer solution during drying. Several idlers (not shown) may be spaced along the underside of upper portion of band 20 to provide support of the band 20. As the band 20 can be a very expensive piece of equipment, any complications of production which might tend to damage the band 20 should be avoided. As the dimensions of the band 20 change—even incrementally due to heating or cooling—the band 20 can begin to run off one end of a drum. Accordingly, the band preferably is made of stainless steel to address the varying thermal gradient of the system existing between the lead drum 16 and the end drum 18. Other metals or alloys having the proper or desired thermal expansion parameters may also be suitable for construction of a band 20.

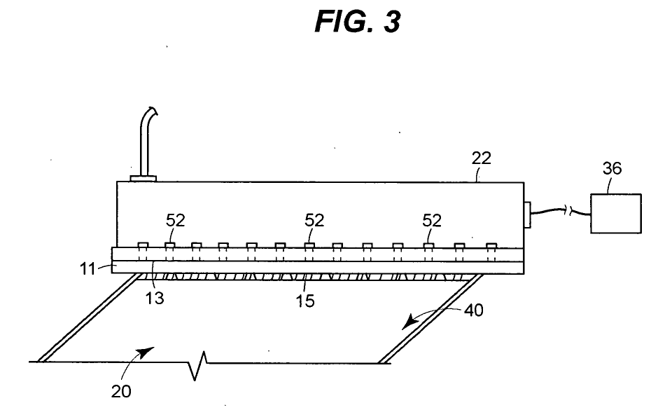

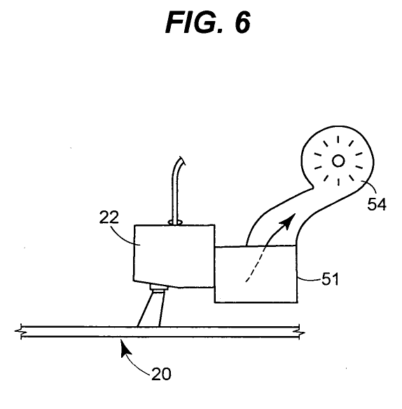

Referring again to FIG. 1, a sheeting or casting die 22 or other device is used to apply the polymer solution from the mixing system 12 to the metal band 20 of the casting machine 14. A feed line 13 is used to feed the polymer solution from the mixing system 12 to the die 22. Referring FIG. 3, the die 22 is shown in greater detail. The die 22 coats a continuous curtain of polymer solution across the width of the band 20. The die 22 includes an internal channel through which the solution flows. At the end of the channel is a slot-shaped orifice 11 which extends across the width of the die 22. An upper surface of the slot is formed by a lip 53 and is deformable with respect to a lower surface 55 of the slot to allow for changes to be made to the dimensions of the slot opening 11. A series of threaded bolts 52 across the width of the die are used to vary the dimensions of the slot opening depending upon the direction of rotation of the bolts. A vacuum box blower 54 and vacuum box 51, which can be seen in FIG. 6, are positioned adjacent the automated die 22 to create a pull on the film solution to be more perpendicular onto the band 20, counteracting the natural tendency of the rotating band to pull the solution out of or away from the die 22. The vacuum box system creates an area of low pressure behind the curtain of solution. By varying the magnitude of this low pressure area, it is possible to control the angle at which the curtain of solution contacts the belt 20.

A drying chamber 24 (see FIG. 1) is shown enclosing a portion of the metal band 20 downline of the sheeting die 22. The drying chamber 24 of the present embodiment comprises an up-line zone 26 and a downline zone 28. Each zone 26, 28 includes a heater 30 located near an air inlet 32 proximal to the downline end of the zone 26, 28. The heaters 30 are adapted for introducing heated air into the drying chamber 24. Each zone 26, 28 also includes an exhaust blower 34 located near an air outlet 38 proximal to the upline end of the zones 26, 28. The heater 30, air inlet 32, air outlet 38 and blower 34 all combine to produce a heated air flow within the drying chamber 24 in each zone 26, 28. The portion of the metal band 20 within the drying chamber 24 at any given time, travels over and is supported by a series of support rollers or idlers 40. The embodiment shown in FIG. 1 includes a series of idlers 40 representing the combination of idlers and associated sensors for monitoring rotation of the idlers.

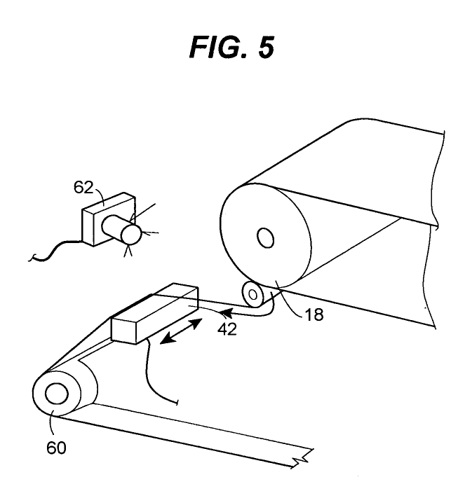

At the end drum 18, the dried film material is removed (in any conventional manner) from the band 20. A take-up winder 60 can be used to spool the finished film product, as shown in FIG. 5. Material may be trimmed from the edges of the film and spooled on a trim rewinder (not shown). Also, quality inspection devices such as a camera 62 and a gauge scanner 42 may be positioned to monitor the film as it is being removed from the band 20.

Referring again to FIG. 1, at the return side of the metal band 20, a surfactant applicator 31 is positioned to apply surfactant to the metal band 20. The surfactant applicator is preferably positioned at the return portion of the band, but practically can be positioned in any location upline of the die 22 and downline of film removal. Also at the underside of the metal band 20, a buffer 66 is preferably present and is configured to pivotably abut the metal band 20. The buffer 66 may be used to create a desired gloss level on the band 20, in order to aid in producing a bubble-free film. The buffer 66 may be positioned upline or downline of the surfactant applicator 31, and preferably is downline. Finally, a system controller 36 is shown, wherein the operation of at least one of the mixing system 12, the band casting machine 14, the sheeting die 22, the drying chamber 24, the take up winder 60, the trim winder (not shown), the surfactant applicator 31, and the buffer 66 is monitored and/or controlled by the system controller 36.

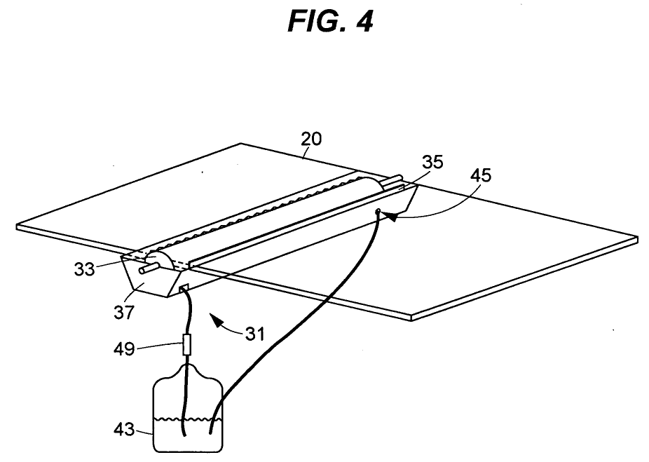

Referring to FIG. 4, an embodiment of a roll coater surfactant applicator is depicted in more detail. The surfactant applicator 31 includes a roller 33 in communication with a trough 37 for containing surfactant, and with the surface of the band 20. A pad 35 (e.g., an absorbent pad such as a felt pad) is shown for reducing the occurrence of excess surfactant, e.g., by absorbing and/or wiping away any excess surfactant.

In the embodiment shown, the surfactant applicator 31 is positioned to apply surfactant to the outer surface of the band 20 by contact. In a preferred embodiment, a roller 33 applies a thick layer of surfactant prior to a felt pad 35 removing excess surfactant. The roller 33 communicates with surfactant fluid in the trough 37, which runs the width of the band 20. Many other embodiments of the present invention are possible, the primary components being a surfactant applicator which communicates surfactant fluid from a source of surfactant fluid to the surface of the band. Preferably, the surfactant applicator applies the surfactant via contact transfer, although other coating methods and suitable devices can be used. Suitable devices (and associated methods) include gravure coating, reverse roll coating, knife-over-roll coating (a.k.a. gap coating), metering rod (a.k.a. Meyer rod) coating, slot die coating (as with the preferred polymer solution coater), and curtain coating.

Preferably, the primary source of surfactant for the roller is a reservoir (e.g., a trough) disposed in proximity to the applicator, although it may be in a remote location and connected via a fluid conduit. Preferably, a surfactant applicator includes (by integration, association, or both) a device for removing excess surfactant, although such a device may not always be necessary. Any suitable device can be used, including those known in the art such as, but not limited to, a metering rod (a.k.a., a meyer bar or rod), a knife, an air knife, a doctor blade, a metering roller, an absorbent pad, and the like. The surfactant applicator is disposed in operational proximity to communicate surfactant fluid to the casting surface. For example, if the applicator is a roller, then it is disposed in contactable proximity to the casting surface, and if the applicator is a spray nozzle, then it is disposed in a location such that the spray pattern of the nozzle reaches the casting surface.

The preferred embodiment of the application device is a roller 33 (FIG. 4), which is preferably wrapped with rubber, but may be made of any other material suitable for coating transfer and may include a non-planar surface. The application device may, alternatively, take the form of a sponge, a brush, or a pad that is in communication with a surfactant source. A nozzle or group of nozzles may be used instead to spray surfactant onto the band surface, rather than applying it using physical contact. In addition, the band could be “dipped” in a reservoir filled with surfactant by directing the band through the container so that it is partially or totally submerged, thereby soaking it with surfactant. Also, a plurality of rollers may be used to coat the band with surfactant, rather than just a single roller 33. Further additional embodiments may be apparent to those skilled in the art.

If a device for removing surfactant is necessary, it may take one of several forms. The preferred embodiment is a dense felt pad 35 (FIG. 4). Any type of pad, flap, or strip made of rubber or any other suitable material may be suitable. Devices which contact the belt are contemplated, and such a device may commonly be referred to as a squeegee. A sponge in contact with the band would also function well to remove excess surfactant. In addition, a pneumatic or forced-air mechanism could function to remove excess surfactant, such as that that described in U.S. Pat. No. 4,421,154 (“Fail Safe Air Wipe”) or variations thereon. Although the device described in U.S. Pat. No. 4,421,154 does not operate with a surfactant applicator, and functions to wipe liquid completely from the band, a variation of such an apparatus could operate effectively within the present invention. Further additional embodiments may be apparent to those skilled in the art.

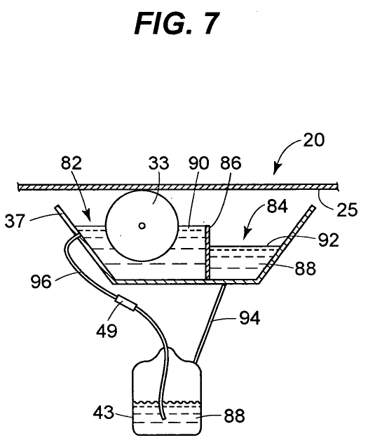

The preferred embodiment of the surfactant source is a trough 37 (FIG. 4) containing surfactant, which is in communication with the roller 33. The trough 37 contains an overflow orifice 45 through which excess surfactant flows back to a surfactant supply in the form of an external reservoir 43. Provision of an overflow orifice 45 aids in maintaining a constant fluid level for immersion and wetting of roller 33. In another embodiment (described in detail in connection with FIG. 7), the overflow drain from the trough takes the form of a weir. A pump 49 is used to deliver surfactant to the trough 37. This continuing motion (i.e., turnover, recycling) of the surfactant solution helps keep the solution from separating, in addition to preventing overheating of the solution in the trough 37 (e.g., which could otherwise occur as the result of conductive and convective heat transfer from a metal band which is used as a casting surface and then heated to more efficiently drive off solvent). Alternatively, this surfactant source may take one of many forms, because different embodiments of the application device may function more efficiently with, or even necessitate, a different embodiment of the surfactant source. The use of a sponge, brush, or pad as the application device may necessitate a means of soaking the device with surfactant, such as by gravity (a tank situated above the device and in communication with it) or forced flow (a tank connected to the device through tubing or pipe). If an absorbent roller is used rather than a rubber roller, the surfactant source could be located internally within the roller. If spraying nozzles are used as the application device, a tank could be connected to the nozzles in a pressurized manner. In addition, if the surfactant is applied through dipping, the application device and the surfactant source would be, at least in part, the same structure. Those skilled in the art could easily envision a number of possible surfactant sources, and only the nature of the application device limits the possible structure of this source.

In the embodiment shown in FIG. 7, the trough 37 is divided in to primary and secondary channels 82 and 84, respectively by an overflow drain in the form of a weir 86. In an alternative embodiment, the trough 37 can include weirs 86 on each side of the roller 33, in order to form three channels, one on each side of the roller 33. Surfactant fluid 88 is supplied from the external reservoir 43 through conduit 96 and pump 49 to fill channel 82 to a level 90 dictated by the height of weir 86. Conduit 96 can introduce surfactant at any point in the channel 82, and disposing the inlet of the conduit 96 directly underneath the roller 33 and at an angle off the vertical (e.g., 5 to 45 degrees from vertical, preferably 10 to 20 degrees or 15 degrees), to direct the flow opposite the direction of band travel, assists in preventing foaming in the channel 82. The roller 33 is disposed within the channel 82 of the trough 37 in contact with the fluid therein. The roller 33 as shown transfers surfactant fluid 88 to the casting surface 25 of the band 20 by direct contact. Surfactant fluid 88 overflows weir 86 into channel 84, which is maintained at lower level 92 by the difference in rates of flow over weir 86 and through an outlet orifice (not shown) in the wall of the trough 37. The outlet orifice in the embodiment shown in FIG. 7 is positioned at the bottom of the channel 84 in the trough 37, and connected by conduit 94 to the external reservoir 43, although it could easily be positioned higher in the side wall of the trough 37 to form another overflow drain. The overflow weir can further aid in maintaining a constant level of fluid in which roller 33 is immersed, and can handle greater variations in rate of surfactant fluid supply to the trough 37 while maintaining immersion of the roller 33 and preventing overflow of the trough 37.

The preferred surfactant is a solution of ZONYL FSP surfactant manufactured and sold by E.I. du Pont de Nemours and Company. The surfactant can be used in pure form or diluted, and preferably is diluted. A solution in a range of about 0.05% by weight to about 5.0% by weight of ZONYL surfactant is preferred. However, other suitable surfactants may be used for producing the desired bubble-free film.

In the present embodiment, the surfactant applicator 31 is not controlled by the system controller 36, but is instead maintained manually by the machine operator. However, in other embodiments, the system controller 36 may be configured to control the surfactant applicator 31.

While not wishing to be bound by any particular theory, it is believed that the use of a surfactant can aid in the elimination of bubbles through one or more mechanisms. When a steel band is coated initially, adsorbed air on the surface is displaced by a surfactant solution via the mechanism known as hard surface spreading wetting. Eliminating adsorbed air prevents the air from forming bubbles in the film product. In addition or in the alternative, a surfactant may lower the surface energy of the steel band so that the polymer solution, also containing surfactant, will “wet-out” more efficiently, i.e., it will spread more widely and evenly over the surface of the band. The improved wet-out prevents air being trapped at the band surface by the polymer solution.

Different types and amounts of surfactant may be used, and varying either the type or amount may have a positive or negative effect on the elimination of bubbles or film release properties. The preferred surfactant is a solution of ZONYL FSP brand surfactant, a fluorosurfactant manufactured and sold by E.I. du Pont de Nemours and Company. However, other suitable surfactants may be used for producing the desired bubble-free film, including, but not limited to other fluorosurfactants. The surfactant can be, and preferably is, diluted. A range of from about 0.05% by weight to about 5.0% by weight of surfactant is preferred for surfactants, including fluorosurfactants such as ZONYL FSP surfactant. The amount of surfactant required to provide adequate wet-out can vary depending on the film being coated on the band. Other products may require higher concentrations to improve release properties. Hard surface spreading wetting will be more efficient with higher surfactant concentrations until the surfactant solution reaches the critical micelle concentration (CMC). This concentration represents a threshold beyond which additional surfactant will not produce any further efficiency in spreading wetting. However, increasing the concentration beyond the CMC may improve wet-out by the polymer solution and improve the release properties of some film formulations.

Specific embodiments contemplated will now be described. First is an apparatus for solvent casting as described herein, including a rotating casting surface (e.g., a metal band tensioned around first and second drums), a sheeting die for applying a polymer solution to the casting surface, and a surfactant applicator disposed in operational proximity to communicate surfactant fluid to the casting surface. The surfactant applicator can include one or more of a roller or a plurality of rollers, at least one of which is disposed to be contactable with the casting surface, or a spraying nozzle, or a sponge disposed to be contactable with the casting surface, or a brush disposed to be contactable with the casting surface, or a pad disposed to be contactable with the casting surface, or reservoir adapted to contain surfactant fluid, the reservoir disposed for the casting surface to contact the surfactant fluid in the reservoir. The apparatus can also include a surfactant remover, including one or more of a felt pad disposed for contact with the casting surface, or a squeegee disposed for contact with the casting surface, or an air knife, or a sponge disposed for contact with the casting surface. The surfactant preferably includes a fluorosurfactant, such as ZONYL FSP surfactant. The surfactant applicator system is preferably used with a polymer solution including polyvinyl alcohol in aqueous solution. The surfactant applicator system can be adapted for control by an electronic system controller, such as by automatic control. The surfactant applicator system preferably is disposed upline of a polymer solution sheeting die and downline of a take-up winder, when used.

A method embodiment can include the steps of applying a surfactant to a casting surface (e.g., a continuous surface, such as a continuous metal band in a band casting machine including at least first and second rotating drums about which the metal band is tensioned and travels with the rotation of the drums); applying a polymer solution to the casting surface to coat at least a portion of the casting surface, the polymer solution including a polymer dissolved in a solvent; removing solvent from the cast polymer solution to produce a polymer film; and removing the polymer film from the casting surface. The solvent (e.g., water) can be removed by drying the cast polymer solution (e.g., polyvinyl alcohol in aqueous solution) in a drying chamber. The surfactant can be applied to the casting surface by wetting the casting surface with surfactant and removing a portion of the wetted surfactant. The surfactant in the method preferably includes a fluorosurfactant, such as ZONYL FSP surfactant. The method can be used to produce a bubble-free film, and can be practiced continuously.

### EXAMPLE 1

A bubble reduction trial took place during May, 2000 in which two surfactants were evaluated for their effectiveness at reducing bubbles. In the first trial, 3.0 mil MONOSOL M-8630 PVOH film was produced on a band with no surfactant coating and on a band continuously coated with a 2% solution of TECHNOL AE-106 surfactant. A film sample was obtained at each condition and each sample was inspected for bubbles at 70 locations. Samples were obtained by taking one full-width sample from each roll. Each sample was inspected for bubbles at 70 separate locations, by use of microfiche. These 70 locations were chosen by performing 5 inspections in each of 14 “inspection lanes.” The bubbles that occurred within one square inch of the microfiche screen were counted. Since the magnification of the microfiche screen was 36×, the actual size of each inspection area was 0.000772 square inches. Therefore, to estimate the number of bubbles in one actual square inch of film, it is necessary to multiply by 1296. The film produced with the continuous coating of TECHNOL AE-106 exhibited a 92.09% reduction in bubbles over a sample produced without any surfactant coating. In the second trial, 3.0 mil MONOSOL PXP-4045 (now called M-4045) was produced on a band with no surfactant coating and on a band continuously coated with a 2% solution of TECFLO 530 surfactant. Samples were obtained and tested as described above. In this trial, film produced with the continuous coating of TECFLO 530 solution exhibited a 37.56% reduction in bubbles. Data from the trial is summarized in Table 1 below. This illustrates the improvement in film quality that may be gained through use of the surfactant.

TABLE 1

| | | |
|---|---|---|
| Bubble Count | | |
| Inspection Lane | Sample | Density |

| | | | | | | | | | | | | | | | | | | |
|---|---|---|---|---|---|---|---|---|---|---|---|---|---|---|---|---|---|---|
| Rep. | Film | Roll# | 1 | 3 | 6 | 9 | 12 | 18 | 24 | 28 | 34 | 40 | 43 | 46 | 49 | 51 | average | bubbles/sq. in. |

| | | | | | | | | | | | | | | | | | |
|---|---|---|---|---|---|---|---|---|---|---|---|---|---|---|---|---|---|
| 1 | M8630 | 105100-02 | 18 | 17 | 20 | 14 | 15 | 9 | 3 | 7 | 8 | 23 | 17 | 19 | 14 | 24 | Bubble density |
| 2 | | | 17 | 16 | 17 | 13 | 9 | 7 | 7 | 7 | 12 | 20 | 17 | 20 | 13 | 21 | comparison |

| | | | | | | | | | | | | | | | | |
|---|---|---|---|---|---|---|---|---|---|---|---|---|---|---|---|---|
| 3 | Control - no coating | 14 | 16 | 13 | 10 | 20 | 6 | 7 | 6 | 9 | 21 | 15 | 24 | 12 | 25 | |
| 4 | | 11 | 15 | 16 | 17 | 12 | 12 | 4 | 6 | 8 | 19 | 18 | 21 | 11 | 20 | 92.09% |

| | | | | | | | | | | | | | | | | | | | |
|---|---|---|---|---|---|---|---|---|---|---|---|---|---|---|---|---|---|---|---|
| 5 | | | 15 | 12 | 12 | 10 | 9 | 10 | 5 | 6 | 8 | 21 | 20 | 22 | 11 | 20 | 13.90 | 18,014 | Bubble reduction |
| 1 | M8630 | 105100-05 | 2 | 0 | 0 | 0 | 1 | 0 | 0 | 0 | 0 | 1 | 1 | 1 | 0 | 5 | | | in coated sample |
| 2 | | | 0 | 1 | 1 | 0 | 0 | 0 | 0 | 0 | 0 | 1 | 0 | 4 | 1 | 8 | | | |
| 3 | Coated | | 0 | 1 | 0 | 0 | 2 | 0 | 1 | 0 | 0 | 0 | 0 | 3 | 0 | 13 | | | |
| 4 | | | 1 | 0 | 2 | 1 | 0 | 0 | 0 | 0 | 0 | 1 | 0 | 1 | 0 | 7 | | | |
| 5 | | | 0 | 0 | 1 | 1 | 1 | 0 | 0 | 0 | 0 | 2 | 0 | 2 | 3 | 7 | 1.10 | 1,426 | |
| 1 | PXP4045 | 105110-03 | 22 | 27 | 24 | 19 | 14 | 8 | 2 | 2 | 13 | 20 | 21 | 21 | 14 | 22 | | | Bubble density |
| 2 | | | 24 | 18 | 17 | 21 | 21 | 9 | 1 | 2 | 11 | 18 | 17 | 16 | 11 | 24 | | | comparison |

| | | | | | | | | | | | | | | | | |
|---|---|---|---|---|---|---|---|---|---|---|---|---|---|---|---|---|
| 3 | Control - no coating | 21 | 17 | 21 | 17 | 20 | 10 | 3 | 1 | 8 | 24 | 15 | 18 | 13 | 25 | |
| 4 | | 20 | 25 | 21 | 16 | 19 | 10 | 0 | 1 | 10 | 23 | 19 | 23 | 13 | 20 | 37.56% |

| | | | | | | | | | | | | | | | | | | | |
|---|---|---|---|---|---|---|---|---|---|---|---|---|---|---|---|---|---|---|---|
| 5 | | | 16 | 16 | 18 | 17 | 18 | 12 | 1 | 5 | 9 | 21 | 14 | 19 | 13 | 22 | 15.33 | 19,866 | Bubble reduction |
| 1 | PXP4045 | 105110-05 | 15 | 16 | 11 | 10 | 15 | 4 | 0 | 2 | 1 | 11 | 6 | 13 | 11 | 17 | | | in coated sample |
| 2 | | | 18 | 13 | 10 | 10 | 9 | 6 | 3 | 0 | 2 | 13 | 7 | 10 | 4 | 21 | | | |
| 3 | Coated | | 16 | 11 | 10 | 12 | 10 | 5 | 1 | 0 | 2 | 7 | 11 | 13 | 8 | 22 | | | |
| 4 | | | 19 | 13 | 9 | 6 | 15 | 3 | 0 | 1 | 4 | 11 | 9 | 12 | 10 | 21 | | | |
| 5 | | | 18 | 11 | 8 | 9 | 16 | 5 | 3 | 1 | 8 | 13 | 9 | 20 | 7 | 23 | 9.57 | 12,405 | |

Note:
each inspection location equals 1/1296 square inches

The foregoing description is given for clearness of understanding only, and no unnecessary limitations should be understood therefrom, as modifications within the scope of the invention will be apparent to those having ordinary skill in the art. Throughout the specification, where the apparatus and method are described as including components or process steps, it is contemplated that they can also consist essentially of, or consist of, any combination of the recited components or steps, unless described otherwise.

1. A roll coating apparatus, comprising:
a trough comprising an overflow drain;
a feed conduit having a first end disposed to feed fluid to the interior of the trough;
a pump in fluid communication with the feed conduit; and
a cylindrical roller disposed at least partially inside the trough.

2. An apparatus according to claim 1, wherein the overflow drain comprises an orifice in fluid communication with a reservoir external to the trough and wherein the feed conduit further comprises a second end disposed in fluid communication the external reservoir.

3. An apparatus according to claim 1, wherein the overflow drain comprises an overflow weir dividing the trough into primary and secondary channels, the roller is disposed in the primary channel, and the secondary channel comprises an outlet orifice.

4. A continuous solution casting system, comprising:
a rotating casting surface;
a polymer solution applicator disposed in proximity to the casting surface; and
a roll coating apparatus according to claim 1,
the roll coating apparatus disposed beneath the rotating casting surface.

5. A system according to claim 4, wherein the rotating casting surface comprises a metal band tensioned about first and second rotating drums.

6. A system according to claim 4, wherein the feed conduit is in fluid communication with a source of fluid surfactant.

7. A system according to claim 6, wherein the surfactant comprises a fluorosurfactant.

8. A system according to claim 7, wherein the surfactant comprises ZONYL FSP surfactant.

9. A system according to claim 4, wherein the polymer solution applicator is disposed in fluid communication with a source of a water-soluble polymer solution.

10. A system according to claim 9, wherein the water-soluble polymer comprises a polyvinyl alcohol.

11. A system according to claim 4, comprising a plurality of rollers, at least roller disposed in the trough and at least one roller disposed to be contactable with the casting surface.

12. A system according to claim 4, further comprising a surfactant remover disposed for contact with the casting surface downline of the roll coating apparatus.

13. A system according to claim 12, wherein the surfactant remover is selected from the group consisting of an absorbent pad, a squeegee, a sponge, an air knife, a doctor blade, and combinations thereof.

14. A system according to claim 4, further comprising a heater disposed in operational proximity to the casting surface downline of the polymer solution applicator.

15. A continuous solution casting system, comprising:
a rotating casting surface comprising a metal band tensioned about first and second rotating drums;
a polymer solution casting die disposed in proximity to the casting surface; and
a roll coating apparatus disposed beneath the rotating casting surface, the roll coating apparatus comprising:
a trough comprising a drain orifice;
a reservoir external to the trough, the drain opening in fluid communication with the external reservoir;
a cylindrical roller disposed at least partially inside the trough;
an overflow weir dividing the trough into primary and secondary channels, the roller disposed within the primary channel and the drain orifice disposed in the secondary channel;
a feed conduit having a first end disposed to feed fluid to the primary channel of the trough and a second end disposed in fluid communication the external reservoir;
a pump in fluid communication with the feed conduit.

16. A system according to claim 15, wherein the reservoir and trough contain a fluid surfactant.

17. A system according to claim 16, wherein the surfactant comprises a fluorosurfactant.

18. A system according to claim 17, wherein the polymer solution casting die is in fluid communication with a source of water-soluble polymer in solution.

19. A system according to claim 18, wherein the water-soluble polymer comprises polyvinyl alcohol.

20. A system according to claim 19, further comprising a surfactant remover disposed for contact with the casting surface downline of the roll coating apparatus.
